(19) United States
(12) Patent Application Publication
(10) Pub. No.: US 2006/0245358 A1
(43) Pub. Date: Nov. 2, 2006

(54) Acceleration of data packet transmission

(76) Inventor: Harlan Titus Beverly, McDade, TX (US)

Correspondence Address: William D. Wiese;DuBois, Bryant, Campbell & Schwartz, LLP, Suite 1300, 700 Lavaca Street, Austin, TX, 78701, US

(21) Appl. No.: 11/118,454

(22) Filed: Apr. 29, 2005

(51) Int. Cl. H04J 1/16

(52) U.S. Cl. 370/235

(57) ABSTRACT

An improved method of accelerating packet transmission through a network is disclosed. More specifically, methods and systems are described for the offloading of packets transmitted in a UDP format with a ULP that allows the packets to retain characteristics of packets transmitted under the TCP format. This is useful in accelerating data transmitted in any ULP format and therefore provides a degree of flexibility previously unknown in the art. In addition, methods and systems are provided for a virtualized API which allows data to be transferred through the traditional network device if the new device is not present but directs the traffic through the new device when it is present. Also, a packet abstraction layer is disclosed which uses information from the state field to run the overlay function to map the formats of the incoming and outgoing packets into the format native to the new device.

### TECHNICAL FIELD OF THE INVENTION

The present invention relates to the acceleration of data packets transmitted through a network. More specifically, the present invention allows for the offloading of packets transmitted in a UDP format with a ULP that allows the packets to retain characteristics of packets transmitted under the TCP format. This is useful in applications requiring rapid transmission of data such as video gaming and streaming video applications.

### BACKGROUND OF THE INVENTION

Traditionally, data is delivered through the Internet to an application such as an online video game or streaming video through a traditional network card or network device which handles the acceptance and delivery of raw data packets. These cards or devices process the data packets through network stack interfaces to an application programming interface (API) or an application code which runs within an application while performing the same or similar function as the API. This API or application code could be one of several standard network interfaces, a custom network interface, or part of the computer's operating system such as, for example, the winsock.dll interface in Microsoft's Windows operating system. The API or application code serves as the interface between the network stack and the application.

Typically, data is transported through the network to the application according to transmission control protocol (TCP) format or user datagram protocol (UDP) formats. UDP is a stateless protocol. The server does not maintain a session connection with the client on which the application is running, nor save any information between client exchanges. Each exchange is a completely independent event. Moreover, the UDP protocol does not offer connection control or delivery of messages through the use of acknowledgments and retransmissions. Accordingly, because user datagram protocol (UDP) is a stateless, connectionless network protocol, when packets are transmitted under the UDP, there is no assurance of delivery or packet order.

By contrast, TCP is a stateful protocol. The server maintains a session with the client on which the application is running and, therefore, information between exchanges is maintained. Accordingly, transmission under the TCP protocol is reliable because it is able to transmit acknowledgements and retransmissions. Transmissions can also be ordered because the receiver can determine whether packets that are received are in the proper order or are old. Those skilled in the art will recognize that the combination of reliable and ordered transmission is currently known in the art. Moreover, there are numerous other features that are available in a stateful network, such as, for example, encrypted/decrypted transmissions, designation of transmission priority levels, compression and decompression of data, authentication of data and others.

Because data transmitted under the UDP is stateless, there can be no assurance that it will be delivered in a reliable, ordered manner. This presents a substantial problem in use because many common online gaming and streaming video applications are configured to operate using the UDP format. Therefore, there is a need for a system and method for transmitting data over a network using the existing UDP format but with the features commonly available in stateless protocols, such as reliability, orderedness, encryption/decryption and other features. In addition, there is a need for a device that can accelerate the transmission of data over a network using the existing UDP format but with features commonly available in stateless protocols.

### SUMMARY OF THE INVENTION

The present invention provides an improved method of accelerating packet transmission through a network. More specifically, the present invention allows for the offloading, also referred to as acceleration, of packets transmitted in a UDP format with a ULP that allows the packets to retain characteristics of packets transmitted in a stateful protocol such as the TCP format. Moreover, the present invention is useful in accelerating data transmitted in any ULP format and therefore provides a degree of flexibility previously unknown in the art. Alternative embodiments of the present invention provide a virtualized API which allows data to be transferred through the traditional network device if the new device is not present but directs the traffic through the new device when it is present. Yet another alternative embodiment of the invention relates to a packet abstraction layer which uses packet formatting information stored in the state to run the overlay function which maps the formats of the incoming packets into the format native to the new device.

This invention, together with the additional features and advantages thereof will become more apparent to those of skill in the art upon reading the description of the preferred embodiments, with reference to the following drawings.

### DESCRIPTION OF THE DRAWINGS

A better understanding of the system and method of the present invention may be had by reference to the drawing figures, wherein:

FIG. 1 shows a flow diagram of a method by which data packets are processed for transmission in the present art;

FIG. 2 shows a flow diagram of one embodiment of the present invention;

FIG. 3 shows a flow diagram depicting the decision protocol for determining whether to transmit data through the new device or through the traditional network device;

FIG. 4 shows a flow diagram of the process which occurs within the new device; and

FIG. 5 shows a flow diagram of a UDP with a specific upper layer protocol.

### DESCRIPTION OF THE PREFERRED EMBODIMENTS

The present invention is an improved method and system of delivering data packets over a network. It should be appreciated that the present invention is equally applicable to any network. References to network and other terms used herein may be applicable to the Internet, intranets, wide area networks, local area networks and other configurations where two or more computers are communicatively connected.

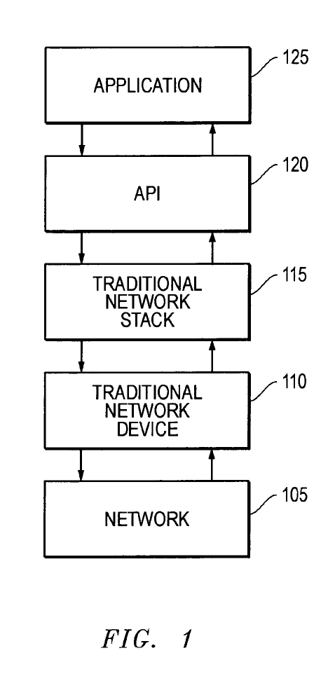

FIG. 1 shows a flow diagram of a method by which data packets are processed for transmission in the present art. Data packets are transmitted through a network 105 to the traditional network device 110. It will be appreciated by those skilled in the art that traditional network cards and network devices often allow for the acceleration of data packets transmitted through UDP such as, for example, through a UDP checksum calculation offload, but that such cards and devices do not recognize the existence of an upper layer protocol (ULP) and therefore contain limitations not found in the present invention. Data is transmitted to the traditional network stack 115 and on to the API 120. A traditional API 120 will provide support for stateless protocol formats and then transmit the data to the application 125. The application 125 sends data back to the network 105 inversely through the same transmission route. There are a number of limitations inherent in the present art, including the lack of reliability in the transmission of data through the network 105 to the application 125, the inability of the traditional network device 110 to order the data packets as they arrive, the inability to encrypt or decrypt the data stream, the inability to set a priority level on the transmitted data, the inability to compress and decompress data transmitted to the application 125 and other similar limitations. One or more of these limitations may be addressed presently through a ULP which may be part of an API, but not through the use of network devices, network stacks or acceleration devices (which are also known as offloading devices).

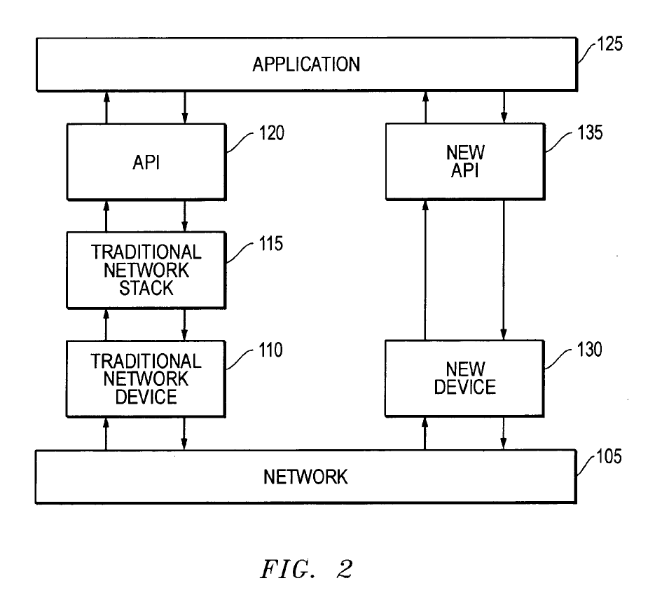

FIG. 2 shows a flow diagram of one embodiment of the present invention in which a new device 130 and a new API 135 are added to the traditional system described above. New API 135 may be a newly-incorporated API, a modification of an existing API, or code that is included within the operating system. New API 135 is functionally able to identify new device 130 and to determine whether new device 130 is present by using methods known in the art such as, for example, operating system interfacing or device registration.

The new device 130 incorporates the network stack as further described below. If the new device 130 is present, new API 135 will work with new device 130 to accelerate the transmission of data packets between the network 105 and the application 125. Rather than burdening the API with the processing the ULP as is the case in the prior art, the new device 130 accelerates the ULP using a custom network stack and certain features included within the new device 130 as discussed in more detail herein. The application 125 does not need to be altered or modified other than a small modification to the workings of the API and the transmission of data through the traditional network device 110 or the new device 130 is entirely transparent to the application 125 which continues to communicate with the API as before any modifications were made.

Although referred to as a “device,” the new device 130 may be configured as hardware, software, or a combination of both. For example, the new device 130 may be hardware such as, for example, a chip (such as a ASIC, an FPGA, a structured ASIC, or a device embedded on a larger chip), a card (such as a PCI card, a PCI-express card, a PCMCIA card, or other such expansion card), or a system (such as a motherboard or a stand-alone device). Alternatively, the new device 130 could be firmware (such as any software running on an embedded device, a PowerPC processor, or other such device) or software (such as any software capable of operating in the relevant environment). Lastly, the new device could be a combination of one or more of the forgoing hardware and software.

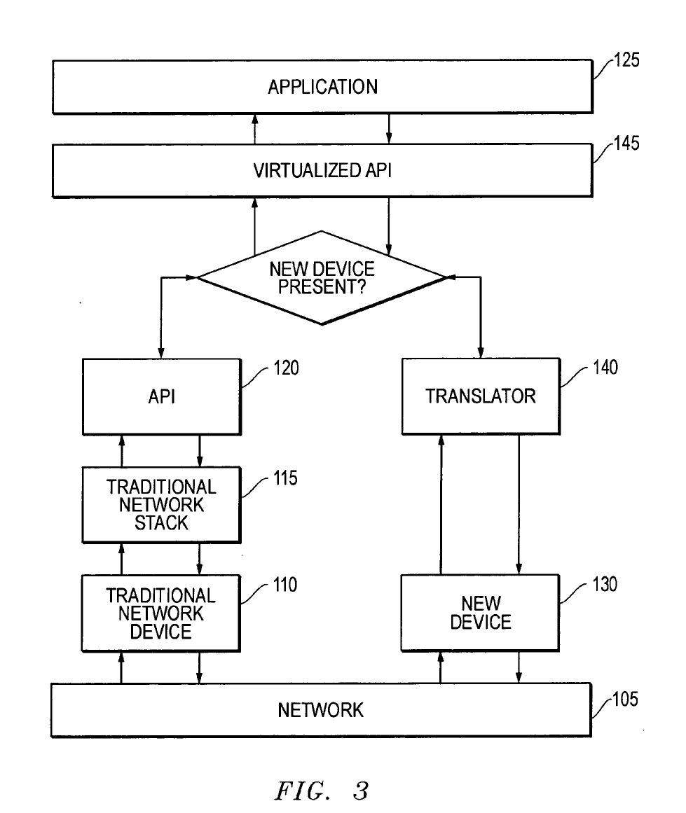

FIG. 3 shows a flow diagram depicting the decision protocol for determining whether to transmit data through the new device 130 or through the traditional network device 110. For the new device 130 to properly function, that is, to properly accelerate the transmission of data to and from the application 125, the implementation of features of the API must be rewritten to accommodate the features supported by the new device 130. This can be accomplished by creating an entirely new API which supports the features of the new device 130. A better alternative, and one embodiment of the present invention, is the use of a virtualized API 145 which allows the same function calls to the API from the application as before.

The virtualized API 145 creates a fork which allows data to be transferred through the traditional network device 110 if the new device 130 is not present but directs the traffic through the new device 130 when it is present. When the new device 130 is present, the traffic passes from the application 125 through a translator 140. The translator 140 translates services normally provided by the API 120 into services recognized by, and useful for, the new device 130. Such services include, for example, reliability, orderedness, priority levels, encryption/decryption, state management, compression and decompression of data, anti-cheating, anti-spoofing and similar services. The translator 140 also provides additional software, when necessary for those services that are not inherent in, or provided by, the current API 120. It is important to recognize that the party sending a transmission through a network, the party receiving data through a network, or both may be utilizing a new device 130 and that the use of such a device would be transparent to the network. In other words, the presence of a new device 130 would not have an adverse effect on the operation of the network or the party with which the new device 130 is communicating on the network.

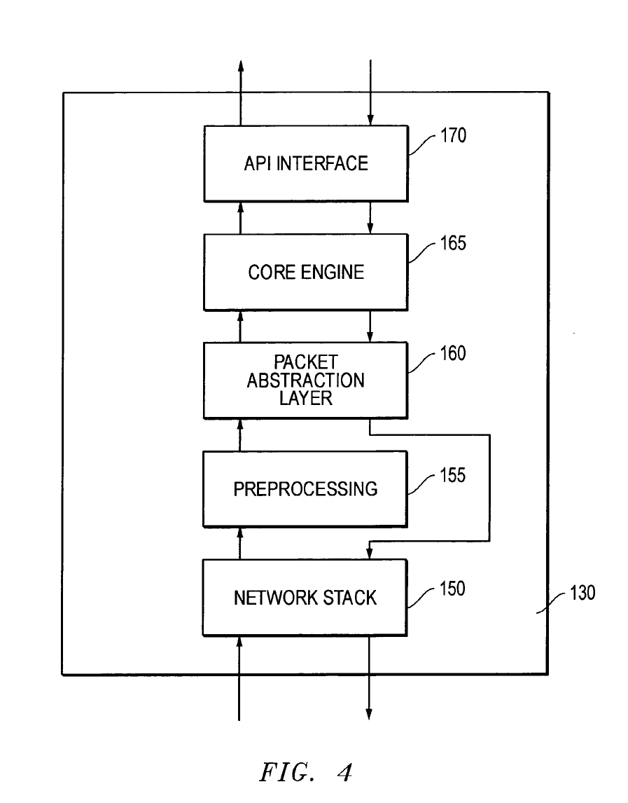

FIG. 4 shows a flow diagram of the process which occurs within the new device 130. Data enters the new device 130 through the network stack 150. This stack may be a standard Berkeley Software Distribution (BSD) UDP/IP stack or other available network stack. The network stack 150 handles Ethernet filtering and UDP and IP checksumming, as well as several basic UDP/IP protocol checks.

Data next flows to pre-processing 155 where the preprocessing and state-fetch algorithms are executed. Typical algorithms such as, for example, binary search, linear search and hashing, are used to identify the State_ID of the connection for the incoming packets. If no connection exists, then the flow is bypassed and ends up in the new API 135 where it will establish a new connection, or not, based on the API's rules and, thereafter, transmit an offload request to the API interface 170. The API interface 170 will create an entry in the State_ID table so that the next time a packet is received or transmitted, it is correctly accelerated through the new device 130.

If a connection does exist and the State_ID has been identified, a piece of information, identified as “state,” is fetched. The state contains the current state of the offloaded connection and loads the appropriate packet abstraction layer routine for that particular connection. It is important to note that many different packet abstraction layers can be resident in the new device 130 at any one time and, as new packets are received, the appropriate packet abstraction layer that is associated with the virtualized API is loaded.

After pre-processing 155, data is transmitted to the packet abstraction layer 160. The packet abstraction layer 160 is designed to understand the format of the packets being received from another protocol and to understand the intent, or the desired function, of those packets. For this reason, the packet abstraction layer 160 must be written in association with the virtualized API 145. These two components work together to virtualize the systems offloading/acceleration capabilities for any arbitrary API's ULP.

The packet abstraction layer 160 uses the information from the state field to run the overlay function to map the formats of the incoming packets into the format native to the core engine 165. The Flags field is used to define which of the fields in the format native to the core engine 165 are required or useful at any specific time depending on the service to be performed by the packet. For example, if the packet is a reliable/ordered type packet, then nearly all of the fields will be relevant. However, if the packet is an ordered only type packet, then only the sequence fields are relevant. The objective of the mapping of these upper layer protocol fields to a well defined structure (such as TCP) is to allow a slightly modified network processing engine, such as, for example, the BSD TCP stack, to interpret the packets. This modified network processing engine is shown in FIG. 4 as the core engine 165.

The modifications required for the core engine 165 to properly function are:

1. Identifying whether support is to be changed from the default reliable and ordered to reliable, ordered, or neither reliable nor ordered;

2. Allow the processing of packets in the format native to the packet abstraction layer 160;

3. Enable retransmission support only for reliable packets; and

4. Allow Timers to be enabled or disabled based on the Flags field for those ULPs that do not use timers.

As previously described, the packet abstraction layer 160 simply maps the format of an incoming packet into the format of a packet that is recognized by the core engine 165 and maps outgoing packets from that format back to the original format for transmission to the network. In one embodiment of the invention, the packet abstraction layer 160 would map the header field of the incoming packet to the following fields, although any arbitrary fields could be used:

| | |
|---|---|
| Sequence Number: | 64-bits |
| Acknowledgement Number: | 64-bits |
| Header Length: | 16-bits |
| Flags: | 32-bits |
| Window Size: | 64-bits |
| Offset Pointer: | 64-bits |
| Priority: | 16-bits |
| Channel: | 16-bits |
| State ID: | 16-bits |
| Option_Length: | 16-bits |
| Option_Fields: | [Option length in bytes] |

Each of the foregoing fields have analogous TCP/IP fields, but the fields have been expanded to encompass a wide variety of ULPs. In fact, it is possible to write an overlay function in the packet abstraction layer 160 that will map any field that may be used in a ULP in an arbitrary packet format into an analogous field in a format that is native to the new device 130. One skilled in the art will recognize that many of the advanced features described above, such as, for example, compression/decompression and encryption/decryption, will transmit the relevant information through the option_fields field. As previously discussed, many different packet abstraction layers can be resident in the new device 130 at any one time and, as new packets are received, the appropriate packet abstraction layer that is associated with the virtualized API as specified in the state for that connection is loaded and the translation occurs.

After leaving the core engine 165, the packets are transmitted to the API interface 170 for queuing and forwarding to the new API 135. The API interface 170 is aware of the new device's 135 buffer preferences or, alternatively, may use pool buffers commonly known in the art. The API interface 170 transmits the data to the new API 135 and then converted back to the virtualized API format so that the conversion of the data is transparent to the application 125 and the application 125 can continue to make the same function calls that it made before the new device 130 and virtualized API 145 were installed.

In another embodiment of the present invention, it may be desirable to combine several of the previously-described elements. For example, in circumstances where the application and the novel device are operating in the same format, the virtualized API 145 and the packet abstraction layer 160 are not necessary. This could streamline the overall architecture of the system and increase the efficiency with which it operates. In another example, the packet abstraction layer 160 could be loaded in the link partner, or computer with which the new device 130 is attempting to communicate. In this case, the data is transmitted through the network in the format that is native to the new device 130, but thereafter translated back to the format recognized by the virtualized API using a packet abstraction layer 160 at the link partner end of the connection. This configuration could also be used to allow two computers that are engaged in communication and that both have the new device 130 to operate without a packet abstraction layer 160, in which case only the virtualized API 145 and the translator 140 are required.

When data is transmitted from the application to the network, the data is processed through the virtualized API 145 where any custom processing not supported by the device is performed, if required, and the API translator 140 is engaged to convert the standard function calls of the application 125 into the format of the new API 135. At this point the State_ID is also identified for later use. Data is then transmitted to the new device 130 via the API interface 170 which queues the data for processing by the core engine 165. The core engine 165 can now accelerate those features as the ULP requires and is supported by the new device using state as is associated with the State_ID saved previously. The packet abstraction layer 160 takes the ULP device formatted packets from the core engine 165 and converts them from the native format of the core engine 165 to the standard format of the virtualized API's ULP. This newly created ULP-formatted packet is sent to the network stack 150 which performs the address resolution protocol when necessary, encapsulates the packet with UDP/IP headers, and sends the packet to the network 105. The use of the packet abstraction layer 160 to convert outbound packets is important for ease of communication between computers that are equipped with the new device 130 and computers that are not. Alternatively, computers that do not have a new device 130 could run the packet abstraction layer 160 directly (i.e. installed directly on the computer rather than on the new device 130) to achieve the same results.

While the foregoing discussion has incorporated examples based on TCP-like reliability services, there are a variety of other services such as, for example, compression/decompression, encryption/decryption, interpolation, prediction, prioritization, flow control, and others, that can be supported by extending the core processing routines. Even though the foregoing discussion has focused on TCP-like services, it is understood that other services are contemplated, and many such services are present today in various ULPs.

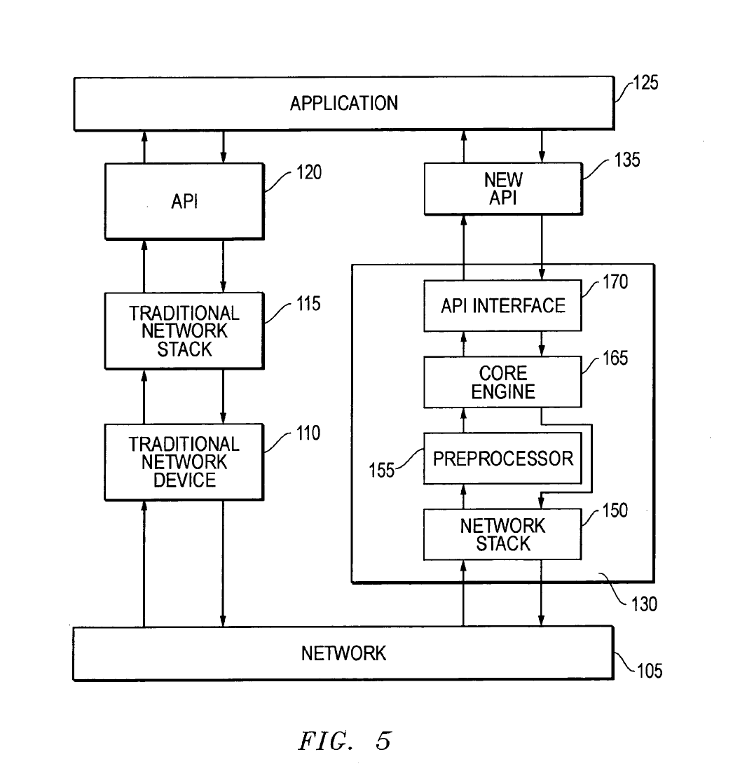

Turning now to FIG. 5 which shows a flow diagram of a UDP with a specific ULP. In this instance, the specific ULP is the ULP native to the new device 130 and, therefore, the virtualized API 145 and the packet abstraction layer 160 are not required. This method requires that the application 125 be rewritten with API function calls to the new API 135. This may be a benefit due to the native support in the application 125 for the acceleration features of the new device 130 and the fact that the packet abstraction layer 160 is not required in the new device 130.

The application 125 transmits to, and receives data from, the new API 135. The new API 135 transmits data to and receives data from, the API interface 170 directly. The API interface 170 queues data from, or to, the core engine 165 which runs in the format that is native to the new device 130. The data is then transmitted directly to the network stack 150, or received from the preprocessor 155, without the need for an intermediary packet abstraction layer 160. As with previous examples, the native format of the new device 130 can be any format and is not limited to a single format.

One benefit of the present invention is the transparency to the application 125 weather it is transmitting to or receiving from an API with an associated new device 130, or an API without an associated new device 130. IN other words, the API function calls made by the application 125 made prior to the installation of new device 130 are the same function calls made by the application 125 after the installation of the new device 130.

It is a further benefit of the present invention to provide for the rapid adoption of the new device's 130 capabilities into any arbitrary API provided certain rules are followed and modules provided, thus providing reduced latency, lower CPU utilization, and generally better network and bus utilization and performance.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments.

The terms “a”, “an” and “the” mean “one or more” unless expressly specified otherwise. Also, devices or code that are in communication with one another need not be in continuous communication with each other unless expressly specified otherwise. In addition, devices or programs that are in communication with one another may communicate directly or indirectly through one or more intermediaries. Further, although process steps, method steps, algorithms or the like may be described in a sequential order, such processes, methods and algorithms may be configured to work in alternate orders. Further, some steps may be performed simultaneously.

When a single device is described herein, it will be readily apparent that more than one device may be used in place of a single device. Similarly, where more than one device is described herein, it will be readily apparent that a single device may be substituted for that one device.

In light of the wide variety of possible networking environments, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method of accelerating the transmission of packets through a network comprising:
offloading packets transmitted through a network in UDP format; and
offloading an upper layer protocol of said packets, wherein said upper layer protocol provides said packets with increased functionality.

2. The method of claim 1 wherein said packet is a datagram consisting of a message transmitted over a packet-switched network and contains the destination address for said packet in addition to the data contained therein.

3. The method of claim 1 wherein said network is one or more networks selected from the group consisting of the Internet, an intranet, a wide area network and a local area network.

4. The method of claim 1 wherein said network is two or more computers communicatively coupled.

5. A method of accelerating the transmission of packets through a network comprising:
means for offloading packets transmitted through a network in UDP format; and
means for including and offloading with said packets an upper layer protocol which provides said packets with increased functionality.

6. The method of claim 5 wherein said packet is a datagram consisting of a message transmitted over a packet-switched network and contains the destination address for said packet in addition to the data contained therein.

7. The method of claim 5 wherein said network is one or more networks selected from the group consisting of the Internet, an intranet, a wide area network and a local area network.

8. The method of claim 5 wherein said network is two or more computers communicatively coupled.

9. A method of accelerating the transmission of packets through a network comprising:
packets containing data, wherein said packets are transmitted through a network to an application, wherein said packets are formatted according to the user datagram protocol;
offloading or accelerating said packets to a device; and
offloading or accelerating an upper layer protocol providing increased functionality in connection with the offloading or acceleration of said packets.

10. The method of claim 9 wherein said packet is a datagram consisting of a message transmitted over a packet-switched network and contains the destination address for said packet in addition to the data contained therein.

11. The method of claim 9 wherein said network is one or more networks selected from the group consisting of the Internet, an intranet, a wide area network and a local area network.

12. The method of claim 9 wherein said network is two or more computers communicatively coupled.

13. The method of claim 9 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

14. A method of accelerating the transmission of packets through a network comprising:
packets containing data, wherein said packets are transmitted through a network to an application, wherein said packets are formatted according to the user datagram protocol;
means for offloading or accelerating said packets to a device; and
means for offloading or accelerating an upper layer protocol providing increased functionality in connection with the offloading or accelerating of said packets.

15. The method of claim 14 wherein said packet is a datagram consisting of a message transmitted over a packet-switched network and contains the destination address for said packet in addition to the data contained therein.

16. The method of claim 14 wherein said network is one or more networks selected from the group consisting of the Internet, an intranet, a wide area network and a local area network.

17. The method of claim 14 wherein said network is two or more computers communicatively coupled.

18. The method of claim 14 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

19. A method of delivering data packets over a network comprising:
sending data from an application, wherein said data requires packetization prior to delivery through a network;
prior to said packetization, detecting whether said packets may be transmitted through a device capable of accelerating the transmission of said packets;
when said device is detected, transmitting said packets through said device so that said packets are transmitted to said application more rapidly than if said packets were not transmitted through said device.

20. The method of claim 19 wherein said packet is a datagram consisting of a message transmitted over a packet-switched network and contains the destination address for said packet in addition to the data contained therein.

21. The method of claim 19 wherein said network is one or more networks selected from the group consisting of the Internet, an intranet, a wide area network and a local area network.

22. The method of claim 19 wherein said network is two or more computers communicatively coupled.

23. The method of claim 19 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

24. The method of claim 19 wherein said application is one or more of video gaming and streaming video.

25. A method of delivering data packets over a network comprising:
sending data from an application, wherein said data requires packetization prior to delivery through a network;
prior to said packetization, detecting whether said packets are transmitted through a device capable of accelerating the transmission of said packets;
when said device is detected, transmitting said packets through said device so that said packets are transmitted to said network more rapidly with less burden on the computer to which said device is attached than if said packets were not transmitted through said device.

26. The method of claim 25 wherein said packet is a datagram consisting of a message transmitted over a packet-switched network and contains the destination address for said packet in addition to the data contained therein.

27. The method of claim 25 wherein said network is one or more networks selected from the group consisting of the Internet, an intranet, a wide area network and a local area network.

28. The method of claim 25 wherein said network is two or more computers communicatively coupled.

29. The method of claim 25 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

30. The method of claim 25 wherein said application is one or more of video gaming and streaming video and audio.

31. A method of delivering data packets over a network comprising:
means for transmitting packets through a network;
prior to transmission of said packet by an application, means for detecting whether said packets are transmitted through a device capable of accelerating the transmission of said packets;
when said device is detected, means for transmitting said packets through said device so that said packets are transmitted to said network more rapidly than if said packets were not transmitted through said device.

32. The method of claim 31 wherein said packet is a datagram consisting of a message transmitted over a packet-switched network and contains the destination address for said packet in addition to the data contained therein.

33. The method of claim 31 wherein said network is one or more networks selected from the group consisting of the Internet, an intranet, a wide area network and a local area network.

34. The method of claim 31 wherein said network is two or more computers communicatively coupled.

35. The method of claim 31 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

36. The method of claim 31 wherein said application is one or more of video gaming and streaming video and audio.

37. A method of improving the speed with which packets are transmitted through a network comprising:
receiving packets intended for an application through a device, wherein said packets are first processed through a network stack;
obtaining the State_ID of the connection of said packet;
mapping the original format of said packet into the native format of said device;
interpreting and processing said packets in said native format using a core engine;
delivering processed data from said packets to an application or an API in a manner useful to said application or said API.

38. The method of claim 37 wherein said packet is a datagram consisting of a message transmitted over a packet-switched network and contains the destination address for said packet in addition to the data contained therein.

39. The method of claim 37 wherein said network is one or more networks selected from the group consisting of the Internet, an intranet, a wide area network and a local area network.

40. The method of claim 37 wherein said network is two or more computers communicatively coupled.

41. The method of claim 37 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

42. The method of claim 37 wherein said application is one or more of video gaming and streaming video and audio.

43. The method of claim 37 wherein said State_ID is entered into a State_ID table.

44. A method of improving the speed with which packets are received from a network comprising:
means for receiving packets intended for an application through a device, wherein said packets are first processed through a network stack;
means for obtaining the State_ID of the connection of said packet;
means for mapping the original format of said packet into the native format of said device;
means for interpreting and processing said packets in said native format using a core engine;
means for delivering processed data from said packets to an application or an API in a manner useful to said application or said API.

45. The method of claim 44 wherein said packet is a datagram consisting of a message transmitted over a packet-switched network and contains the destination address for said packet in addition to the data contained therein.

46. The method of claim 44 wherein said network is one or more networks selected from the group consisting of the Internet, an intranet, a wide area network and a local area network.

47. The method of claim 44 wherein said network is two or more computers communicatively coupled.

48. The method of claim 44 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

49. The method of claim 44 wherein said application is one or more of video gaming and streaming video and audio.

50. The method of claim 44 wherein said State_ID is entered into a State_ID table

51. A method of accelerating the transmission of a packet through a network comprising:
a packet transmitted through a network, wherein said packet is transmitted in a UDP format with a specific ULP, wherein said ULP is native to at least one device through which said packets are transmitted;
operating an application containing API calls to said UDP and said ULP.

52. The method of claim 51 wherein said packet is a datagram consisting of a message transmitted over a packet-switched network and contains the destination address for said packet in addition to the data contained therein.

53. The method of claim 51 wherein said network is one or more networks selected from the group consisting of the Internet, an intranet, a wide area network and a local area network.

54. The method of claim 51 wherein said network is two or more computers communicatively coupled.

55. The method of claim 51 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

56. The method of claim 51 wherein said application is one or more of video gaming and streaming video and audio.

57. A method for virtualizing an application programming interface comprising:
detecting whether or not a device is present on a network and, if present, directing packets through said device;
translating API calls for said packets into a format native to, or recognized by, said device.

58. The method of claim 57 wherein said packet is a datagram consisting of a message transmitted over a packet-switched network and contains the destination address for said packet in addition to the data contained therein.

59. The method of claim 57 wherein said network is one or more networks selected from the group consisting of the Internet, an intranet, a wide area network and a local area network.

60. The method of claim 57 wherein said network is two or more computers communicatively coupled.

61. The method of claim 57 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

62. A packet abstraction layer comprising:
obtaining the state of a connection for which data is to be transmitted;
when receiving said data, using said state to map the format of the packet within which said data is contained into the format native to the device within which the packet abstraction layer resides; and
when transmitting said data, using said state to format native to the device within which the packet abstraction layer resides to the format that is expected by a link partner.

63. The packet abstraction layer of claim 62 wherein said packet is a datagram consisting of a message transmitted over a packet-switched network and contains the destination address for said packet in addition to the data contained therein.

64. The packet abstraction layer of claim 62 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

65. A system for accelerating the transmission of packets through a network comprising:
a network; and
packets transmitted through said network wherein said packets are offloaded in UDP format and said packets include an upper layer protocol which provides said packets with increased functionality.

66. The system of claim 65 wherein said packet is a datagram consisting of a message transmitted over a packet-switched network and contains the destination address for said packet in addition to the data contained therein.

67. The system of claim 65 wherein said network is one or more networks selected from the group consisting of the Internet, an intranet, a wide area network and a local area network.

68. The system of claim 65 wherein said network is two or more computers communicatively coupled.

69. A system for accelerating the transmission of packets through a network comprising:
a network;
an application;
a device communicatively coupled with said network;
wherein data is presented from said application to said device, and therafter, said device offloads the upper layer protocol and the user datagram protocol to create packets which are transmitted through said network.

70. The system of claim 69 wherein said packet is a datagram consisting of a message transmitted over a packet-switched network and contains the destination address for said packet in addition to the data contained therein.

71. The method of claim 69 wherein said network is one or more networks selected from the group consisting of the Internet, an intranet, a wide area network and a local area network.

72. The method of claim 69 wherein said network is two or more computers communicatively coupled.

73. The method of claim 69 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

74. The system of claim 69 wherein said application is one or more of video gaming and streaming video and audio.

75. A system for accelerating the transmission of packets through a network comprising:
a network;
an application;
a device communicatively coupled with said network;
wherein packets are presented from said network to said device, and therafter, said device removes the upper layer protocol and the user datagram protocol to reveal the data which is transmitted to said application.

76. The system of claim 75 wherein said packet is a datagram consisting of a message transmitted over a packet-switched network and contains the destination address for said packet in addition to the data contained therein.

77. The method of claim 75 wherein said network is one or more networks selected from the group consisting of the Internet, an intranet, a wide area network and a local area network.

78. The method of claim 75 wherein said network is two or more computers communicatively coupled.

79. The method of claim 75 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

80. The system of claim 75 wherein said application is one or more of video gaming and streaming video and audio.

81. A system for delivering data packets over a network comprising:
a network;
an application operating on a computer communicatively connected to said network;
a device communicatively connected to said network;
wherein a packet containing data useful to said application is sent through said network, and, prior to receipt of said data by said application, a method is provided for detecting whether said packets are transmitted through a device capable of accelerating the transmission of said packets and, when said device is detected, routing said packets through said device so that said data is transmitted to said application more rapidly than if said packets were not routed through said device.

82. The system of claim 81 wherein said packet is a datagram consisting of a message transmitted over a packet-switched network and contains the destination address for said packet in addition to the data contained therein.

83. The system of claim 81 wherein said network is one or more networks selected from the group consisting of the Internet, an intranet, a wide area network and a local area network.

84. The system of claim 81 wherein said network is two or more computers communicatively coupled.

85. The system of claim 81 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

86. The system of claim 81 wherein said application is one or more of video gaming and streaming video and audio

87. A system for improving the speed with which packets are transmitted through a network comprising:
a network;
an application operating on a computer communicatively connected to said network;
a device communicatively connected to said network, wherein packets sent through said network to said application pass through said device and, within said device,
packets are first processed through a network stack;
a State_ID of the connection of said packet is obtained;
the original format of said packet is mapped into the native format of said device; and
said packets are interpreted in said native format using a core engine.

88. The system of claim 87 wherein said packet is a datagram consisting of a message transmitted over a packet-switched network and contains the destination address for said packet in addition to the data contained therein.

89. The system of claim 87 wherein said network is one or more networks selected from the group consisting of the Internet, an intranet, a wide area network and a local area network.

90. The system of claim 87 wherein said network is two or more computers communicatively coupled.

91. The system of claim 87 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

92. The system of claim 87 wherein said application is one or more of video gaming and streaming video and audio.

93. The system of claim 87 wherein said State_ID is entered into a State_ID table

94. A system for accelerating the transmission of a packet through a network comprising:
a network;
a packet transmitted through said network, wherein said packet is transmitted in a UDP format with a specific ULP, and wherein said ULP is native to at least one device through which said packets are transmitted; and
an application containing API calls to said UDP and said ULP.

95. The system of claim 94 wherein said packet is a datagram consisting of a message transmitted over a packet-switched network and contains the destination address for said packet in addition to the data contained therein.

96. The system of claim 94 wherein said network is one or more networks selected from the group consisting of the Internet, an intranet, a wide area network and a local area network.

97. The system of claim 94 wherein said network is two or more computers communicatively coupled.

98. The system of claim 94 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.

99. The system of claim 94 wherein said application is one or more of video gaming and streaming video and audio.

100. A system for virtualizing an application programming interface comprising:
a network;
packets transmitted through said network;
a device capable of translating information within said packets into a format native to, or recognized by, said device; and
a means for detecting whether or not said device is present on said network and, if present, directing said packets through said device.

101. The system of claim 100 wherein said packet is a datagram consisting of a message transmitted over a packet-switched network and contains the destination address for said packet in addition to the data contained therein.

102. The system of claim 100 wherein said network is one or more networks selected from the group consisting of the Internet, an intranet, a wide area network and a local area network.

103. The system of claim 100 wherein said network is two or more computers communicatively coupled.

104. The system of claim 100 wherein said device is one or more components selected from the group consisting of an ASIC, a FPGA, a structured ASIC, a device embedded on a larger chip, a PCI card, a PCI-express card, a PCMCIA card, other expansion cards, a motherboard, a stand-alone device, software running on an embedded device, a PowerPC processor and software.
